(19) United States
(12) Patent Application Publication
(10) Pub. No.: US 2015/0183295 A1
(43) Pub. Date: Jul. 2, 2015

(54) ELECTRICAL VEHICLE HEATER, IN PARTICULAR FOR VEHICLES HAVING A HYBRID DRIVE OR HAVING AN ELECTRIC DRIVE

(71) Applicant: Behr-Hella Thermocontrol GmbH, Stuttgart (DE)

(72) Inventors: Ralph Trapp, Lippstadt (DE); Dirk Nagel, Lippstadt (DE)

(73) Assignee: Behr-Hella Thermocontrol GmbH, Stuttgart (DE)

(21) Appl. No.: 14/400,841

(22) PCT Filed: May 3, 2013
(86) PCT No.: PCT/EP2013/059276

§ 371 Date: Nov. 13, 2014

(30) Foreign Application Priority Data
May 14, 2012 (DE) 10 2012 207 988.2

(51) Int. Cl. B60H 1/22

(52) U.S. Cl. CPC B60H 1/2218; B60H 1/2225; B60H 2001/2268

(57) ABSTRACT

The electrical vehicle heater, in particular for vehicles having a hybrid drive or having an electric drive, has a heating module (10), which is provided with a carrier body (14), which has two opposite main outside surfaces (20, 21), wherein the carrier body (14)—when observed in the direction of one of the two main outside surfaces (20, 21)—is divided into two adjacent heating zones (16, 18) and wherein the carrier body (14) is provided with at least one heating element (22) in each heating zone (16, 18). Furthermore, the heating module (10) has a control unit (31) for controlling the heating elements (22) independently of each other and at least one heat sink (42, 48), which is thermally coupled to the carrier body (14).

The invention relates to an electrical vehicle heater, in particular for a vehicle having a hybrid drive or an electric drive. The electrical vehicle heater can be an air heater, but also a heater heating a heat transport medium, the heat transport medium giving off its thermal energy, for instance via a heat exchanger, to an airflow flowing into the vehicle.

It is known to equip conventional vehicles, which have internal combustion engines, with an additional electrical heater so that sufficient energy for heating the vehicle interior is available already during the heat-up phase of the engine coolant. Such additional electrical heaters can also be used in vehicles with internal combustion engines, in which, for reasons of their mode of operation or for design reasons, the coolant temperature is too low. Lastly, electrical vehicle heaters are used in particular in vehicles having a hybrid drive or an electric drive.

The known electrical vehicle heaters normally have a plurality of heating modules or heating systems that can be controlled separately. Each heating system comprises one or a plurality of heating elements that are controlled simultaneously in each heating system. Thus, it is not possible to separately control individual heating elements of a heating system. This means that the heating system always has the same temperature over its entire length.

If electrical vehicle heaters with such heating modules or heating systems are installed such that the heating systems are directed vertically or substantially vertically, the airflow passing the electrical vehicle heater can be heated differently for the driver and for the passenger. A so-called dual zone heating can thus be realized in a comparatively simple manner. However, structural space conditions may also require that the electrical vehicle heater has to be or should be installed rotated by 90° with respect to the previously described arrangement. In this case, the airflow passing the heater can be heated to different degrees with respect to flow layers superimposing each other. If it is intended to realize a separate temperature setting and control for the driver and the passenger by means of the heater, this has to be realized in a complex manner using temperature mixing flaps or similar measures, by mixing cold and warm air separately for the driver and the passenger, which, on the one hand, is energetically unfavorable and, on the other hand, can cause the heating module or the heater to be partially sealed-off. Due to this partial sealing, local overheating of the heating module or the heater or in cooling the electronics can occur.

From DE-C-100 32 099 an additional electrical heater for heating the air flowing into the interior of a vehicle is known, which comprises a carrier material strip having two side surfaces, wherein a plurality of strip-shaped heating elements is arranged on at least one of the side surfaces, which elements can be controlled for the purpose of adjusting the heating power. Here, the control is performed in a cascaded manner, that is by sequentially switching on further heating elements for a (step-wise) change (increase or decrease) in heating power. In other words, it is not possible to control the heating elements independently of each other insofar that, when a second heating element is switched on in addition to a first heating element controlled, the first heating element cannot be switched off at some later moment without the second heating element having been switched off before. Thus, this known additional electrical heater does not allow individual heating zones on the heating element to be controlled and heated up independently of each other.

Further, an electrical heating element and a method for manufacturing the same is known from DE-A-10 2010 000 042, and a cooling body is known from DE-A-25 31 450.

It is an object of the invention to provide an electrical vehicle heater, in particular for vehicles having a hybrid drive or having an electric drive, with which different temperature settings for the medium, e.g. air, flowing along different zones of a heating module can be realized for a driver and a passenger in a simple manner. Such a heating module can be used to heat a (e.g. flowing) heat transport medium which specifically is a gas (such as air) or a liquid (such as water).

In order to achieve the object the invention provides an electrical vehicle heater, in particular for vehicles having a hybrid drive or having an electric drive, the heater comprising at least one heating module which is provided with

a carrier body having two opposite main outside surfaces, wherein the carrier body—when observed in the direction of one of the two main outside surfaces—is divided into two adjacent heating zones, and

wherein the carrier body is provided with at least one heating element in each heating zone,

a control unit for controlling the heating elements independently of each other, and

at least one heat exchanger for dissipating thermal energy to a heat transport medium, the heat exchanger being thermally coupled to the carrier body.

Basically, the invention provides a heating module for an electrical vehicle heater (full or additional heater), in which two adjacent heating zones are defined on a carrier body that extends substantially along the entire length of the heating module. Each heating zone can comprise one or a plurality of heating elements in order to be able, for example, to vary the heating power per heating zone. The heating elements can be controlled in a linear or a step-wise manner. The carrier body itself has two opposite main outside surfaces and is preferably strip-shaped. A suitable material for the carrier body is a ceramic material, for example.

When observed in the direction of one of the two main outside surfaces of the carrier body, the same is divided into (at least) two adjacent heating zones. Each heating zone comprises at least one heating element, wherein the heating elements of different heating zones can be controlled independently of each other. A control unit serves this purpose. The control unit comprises an electric circuit, wherein at least one component (e.g. a bipolar, a MOSFET or an IGBT transistor) of the electric circuit generates a power loss in the form of heat. Suitably, this component is situated on the carrier body, specifically in a control zone spatially separated from the heating zones. In this manner, the thermal loss can also be used to control the temperature of the heat transport medium flowing through the vehicle heating system. The heating module is further provided with a heat exchanger that is thermally coupled to the carrier body and is exposed to the heat transport medium to be heated (gas or liquid). Via the heat exchanger, the thermal energy of the heating elements is given off, possibly via an enlarged surface, to the environment, i.e. to the heat transport medium flowing along (gas or liquid). Hereinafter, the heat exchanger is also referred to as a cooling body.

The at least two heating zones are arranged on a common main outside surface or on different main outside surfaces of the carrier body. Finally, it is also possible that heating elements associated with the respective different heating zones are arranged on both main outside surfaces of the carrier body. Accordingly, each heating zone thus comprises heating elements arranged on both main outside surfaces of the carrier body. Suitably, supply lines to the heating elements of the individual heating zones are provided on the heating body, so that the heating elements associated with the different heating zones can also be controlled independently of each other. With the heating module provided by the invention, different regions of a heating system of an electrical vehicle heater can thus be heated to different degrees. If such a vehicle heater is installed such that the heating modules or heating systems extend substantially horizontally, the heat transport medium flowing through the vehicle heater can be controlled to a different temperature in, for instance, its left portion than in its right portion. Thereby, in the case of an air heater for the driver and the passenger, a different temperature setting for the driver side and the passenger side can be achieved in a simple manner without requiring an “after-treatment” of the airflow leaving the vehicle heater. Rather, the same can simply be divided into two partial airflows for the driver side and the passenger side, respectively.

If the heating module of the invention is installed in a vertical orientation, a separate temperature setting for the driver side and the passenger side is also conceivable, wherein in this case, the option of having to heat the heating module to different degrees - seen along its longitudinal extension - can be abandoned.

The electrical vehicle heater of the present invention can thus be changed with respect to the temperature distribution over the surface of the vehicle heater, both in the vertical and the horizontal direction. For example, it is thus possible to realize four partial airflows of a heat transfer medium, each adapted to be heated differently, which airflows, seen in flow section, correspond to four quadrants.

The heating elements may suitably be configured as heating conductor paths which are realized specifically in a paste printing process on a ceramic substrate as the carrier body. The heating conductor paths and other conductor paths on the carrier body can be covered with cover elements (in particular also of ceramic materials), which have an electrically insulating effect, on the one hand, and are electrically conductive, on the other hand, and which can be bonded with the carrier body using glass solder or adhesive. As an alternative, the electrical insulation, and at the same time the thermal conductivity, can also be realized by means of an imide-based plastic film or by glass passivation.

Further advantageous embodiments of the invention are defined in the dependent claims.

For example, it is possible that the electrical vehicle heater has two heat exchangers per heating module, between which a carrier body is arranged thermally coupled to the heat exchangers.

In another advantageous embodiment of the invention it can be provided that the carrier body is strip-shaped and has a longitudinal extension, and that the two heating zones are arranged in series, seen in the direction of the longitudinal extension, on a common main outside surface of the carrier body or on different main outside surfaces of the carrier body with or without mutual overlap.

Further, it is possible that the carrier body has a ceramic substrate, that the heating elements are each designed as heating conductor paths, and that each heating conductor path is covered with one or a plurality of cover elements that is fixedly connected with the ceramic substrate.

In another advantageous embodiment of the invention it is provided that at at least one edge section, the ceramic substrate has a protruding portion projecting beyond the cover element, and that components of a control circuit for the heating elements are arranged in the protruding portion of the ceramic substrate.

Further, it is possible that the or each cover element is designed as a thermally conductive, as well as electrically insulating plastic film which in particular comprises an imido compound or a polyimide, and/or that a thermally conductive paste is provided between each of the main outside surfaces which is provided with at least one heating element, and the cover element or between the cover element and a heat exchanger.

A ceramic material is particularly well suited for the cover element. Preferably, however, a thermally conductive, as well as electrically insulating plastic material film is used. This film is made of a high-performance plastic material that ensures an electrical insulation that is resistant to disruptive discharge, while simultaneously providing good thermal conductivity. Such a plastic material comprises in particular a chemical imido compound or a polyimide. Specifically, the polyimide is a purely aromatic polyimide. Such materials are heat resistant, show little outgassing, are, above that, radiation resistant and have insulating properties. They are dimensionally stable in a temperature range from −273° C. to +440° C. The continuous operating temperature is up to 230° C., with 400° C. being possible for short periods of time. A known material with purely aromatic polyimides that is suited for use in the invention is sold under the name Kapton®. As an alternative, a passivation layer of an electrically insulating and thermally conductive material, e.g. a glass passivation layer, can be applied as a cover material on the ceramic substrate. In this case, a plastic film or a (glass soldered) ceramic cover layer can (but does not have to) be omitted. The above mentioned alternatives make it possible to achieve electrical insulations of up to a few kV of (test) voltage.

Finally, it is also possible that the electrical vehicle heater of the invention comprises a plurality of heating modules, each with two heat exchangers, with cooling fins protruding from opposite sides of a heating module, and a retaining frame in which the heating modules are retained in side-by-side arrangement, wherein the cooling fins of facing heat exchangers of two adjacent heating modules mesh, and/or that the cooling fins of the outer heat exchangers of the two heating modules spaced farthest apart are at least partly covered with cover sections of the retaining frame. As an alternative, the or each heat exchanger can comprise a cooling body with a plurality of mutually adjacent projecting cooling fins between which the heat transport medium can flow through, wherein at least some of the cooling fins have cooling fin sections tilted in opposite directions—seen in the flow direction of the heat transport medium.

In another advantageous embodiment of the invention it can be provided that the heat transport medium flows through and/or around the heat exchanger, thereby forming two partial flows, each of the partial flows being associated with another heating zone of the heating module.

Finally, it is also possible that a plurality of heating modules must be provided, where each heating zone of a respective heating module is associated with another of the two partial flows.

As an alternative to the above described variant, it is also possible, according to the invention, to provide a plurality of heating modules, of which a first set of heating modules, comprising at least one heating module, is associated with a respective one of two partial flows, namely a first or a second partial flow, and of which a second set of heating modules, comprising at least one heating module, is associated with a respective one of two further partial flows, namely a third or a fourth partial flow, wherein the one heating zone of the at least one heating module of the first set is associated with the first partial flow, the other heating zone of the at least one heating module of the first set is associated with the second partial flow, the one heating zone of the at least one heating module of the second set is associated with the third partial flow, and the other heating zone of the at least one heating module of the second set is associated with the fourth partial flow.

As an alternative or in addition to the above mentioned features, the electrical vehicle heater of the present invention can comprise one of the features listed below:

1. A ceramic substrate on which a heat conductor path is printed on one or both sides by means of a paste printing method, the conductor path serving as a heating element, while it is insulated by a thermally conductive film applied onto the conductor path. A cooling or heating body dissipates the heat of the conductor path into the air.

2. A semiconductor component or another component of an electric circuit, by which the heating conductor path can be controlled, can be arranged on the ceramic substrate. The component dissipates its thermal loss to the ceramic substrate, whereby, in turn, the additional heat of the substrate is dissipated to the environment via the heating or cooling body (heat exchanger).

3. As an alternative, a ceramic cover can be fixed for insulation purposes on the conductor path of the ceramic substrate using a thermally conductive adhesive. However, the ceramic cover can also be placed in thermally conductive paste on the ceramic substrate printed on one side and, in this case, is fixed by means of clamps or similar mechanical fastening elements, possibly together with the cooling/heating body.

4. A ceramic substrate on which conductor paths are printed as heating elements on both sides in a paste printing process. Here, the conductor paths are arranged on the two main outside surfaces of the ceramic substrate such that they form two heating zones which are arranged one after the other—seen along the longitudinal extension of the in particular strip-shaped ceramic substrate—and which possibly overlap each other. A thermally conductive film (for example Kapton®), a glass passivation or a ceramic cover are provided on the conductor paths and insulate these conductor paths from the environment, while the thermal conductivity is maintained. The heat of the heating module is emitted into the ambient air or into the airflow via the cooling or heating body.

5. A ceramic substrate on which conductor paths are printed as heating elements on one side in a paste printing process. Here, the conductor paths are arranged on the two main outside surfaces of the ceramic substrate such that they form two heating zones which are arranged one after the other—seen along the longitudinal extension of the in particular strip-shaped ceramic substrate—and which possibly overlap each other. A thermally conductive film (for example Kapton®), a glass passivation or a ceramic cover are provided on the conductor paths and insulate these conductor paths from the environment, while the thermal conductivity is maintained. The heat of the heating module is emitted into the ambient air or into the airflow via the cooling or heating body.

6. One semiconductor component is arranged on the ceramic substrate per heating zone, and possibly also per heating element, with which components the heat conductor paths can be controlled separately. The semiconductor components dissipate their thermal loss to the ceramic substrate and thereby also heat the air.

7. Furthermore, the concept of the present invention can be combined with the features disclosed in WO 2011/120946 A1 and WO 2011/085915 A1. In this respect, the subject matter of the above mentioned documents is incorporated into the present invention by reference.

The invention will be described below with reference to an embodiment thereof, as well as with reference to the drawing. Specifically, the Figures show:

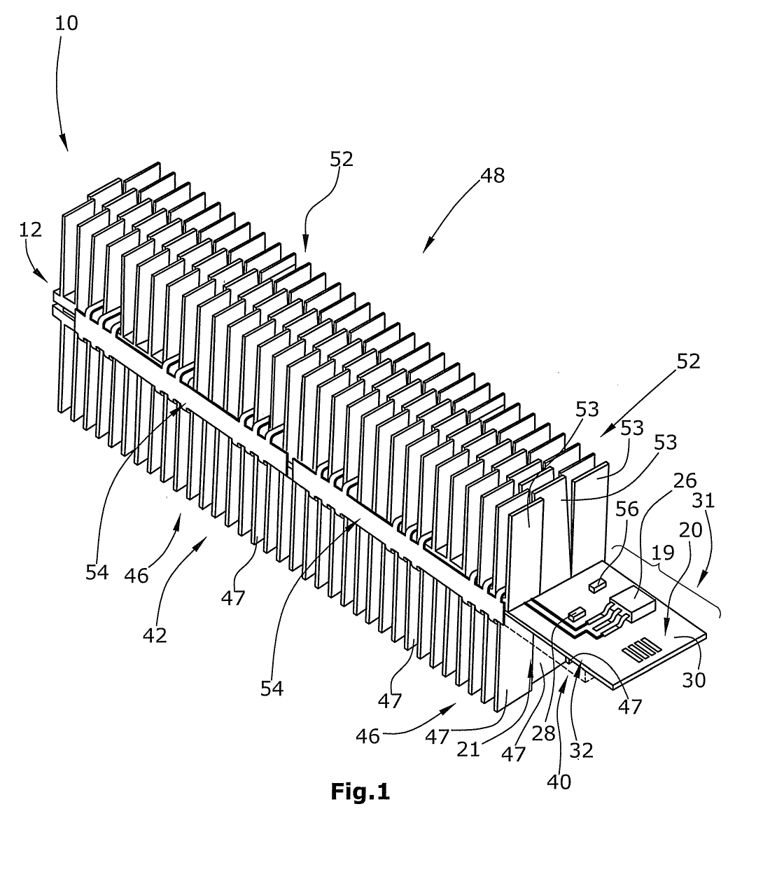

FIG. 1 a perspective view of a heating module,

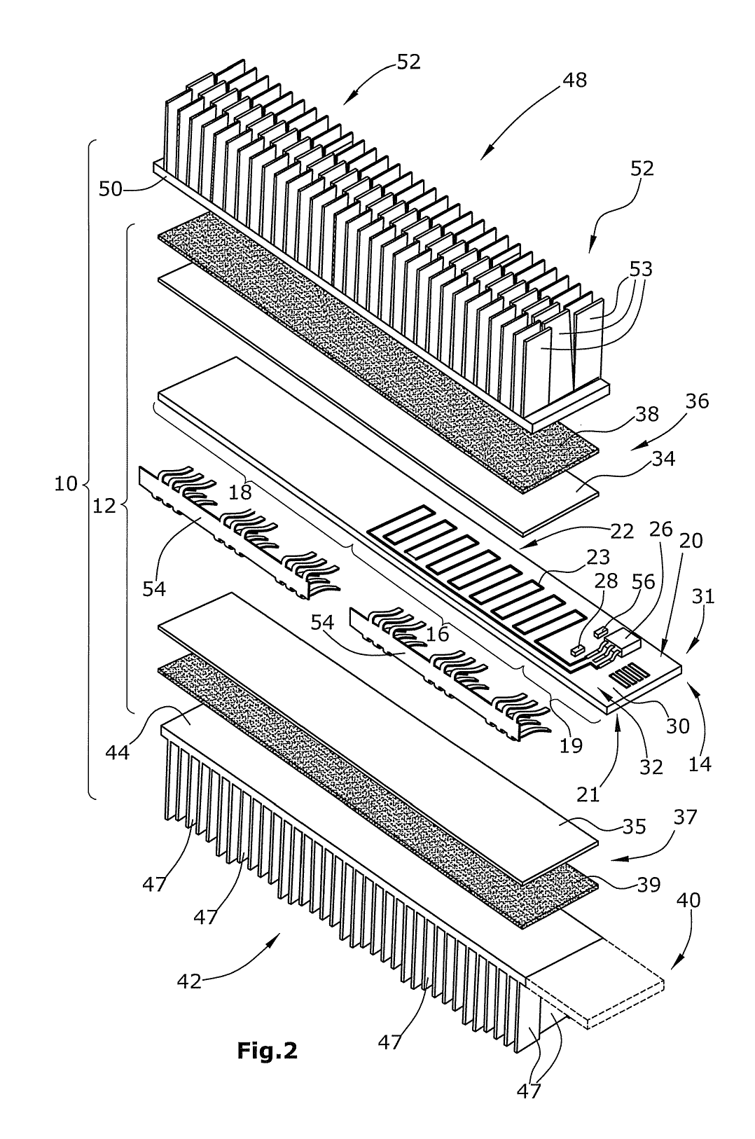

FIG. 2 the heating module of FIG. 1 in an exploded view,

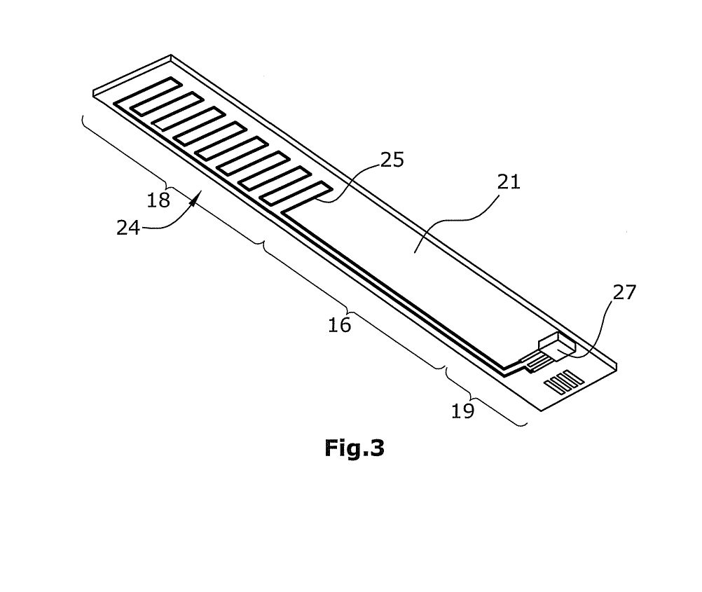

FIG. 3 a view on the bottom side of the heating element or the carrier body of the heating element of the heating module in FIG. 2, and

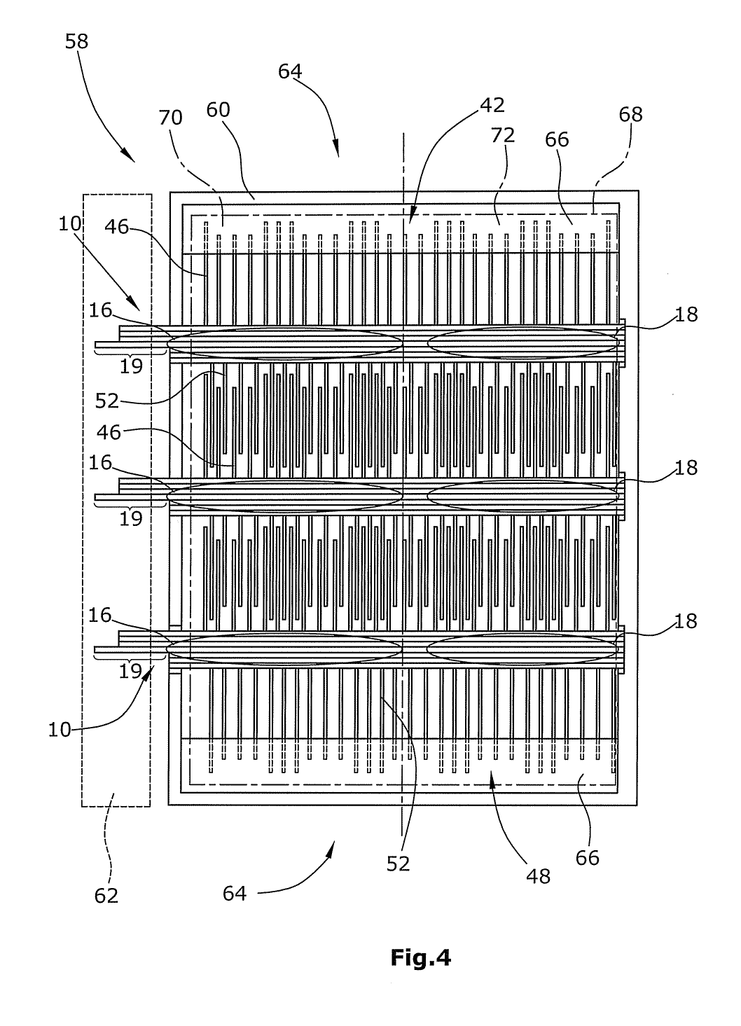

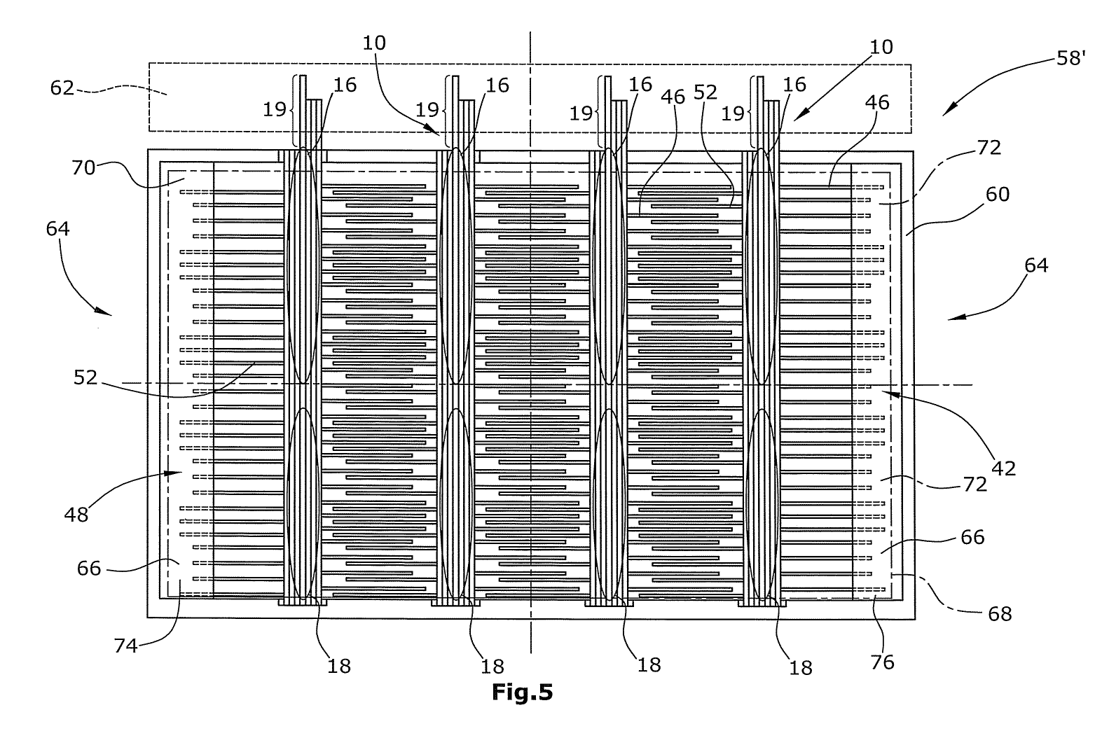

FIGS. 4 and 5

views on two electrical vehicle heaters with a plurality of heating modules of FIGS. 1 to 3, which are arranged horizontally (see FIG. 4) or vertically (see FIG. 5), respectively.

FIG. 1 is a perspective view of a heating module 10 whose structure is shown in a perspective and exploded view in FIG. 2 using an air heating as an example. The heating module 10 is designed for use in high-voltage on-board power supplies of up to 1 kV in vehicles, in particular in hybrid drive vehicles or electric drive vehicles. The heating module 10 has a central electric heating element 12 having a layered structure according to the description below. The heating element 12 comprises a ceramic substrate 14 divided into two heating zones 16 and 18 and a control zone 19. Both heating zones 16, 18 can be located, for example, on the upper side 20 of the ceramic substrate 14 in FIG. 2. However, in this embodiment, one heating zone 16 is located on the upper side 20 of the ceramic substrate 14 and the second heating zone 18 is located on the bottom side 21 of the ceramic substrate 14 (cf. the view on the bottom side of the ceramic substrate 14 in FIG. 3). The outstanding feature of the two heating zones 16, 18 lies in the fact that, with respect to the longitudinal extension of the strip-shaped ceramic substrate 14, the zones are arranged to be adjacent, while they can possibly also overlap. In other words, seen in the direction of the longitudinal extension of the ceramic substrate 14, the two heating zones 16 and 18 and the control zone 19 are arranged one after the other. Per heating zone 16, 18, one resistance-heating element 22 and 24 in the form of a resistance-heating conductor 23 and 25 is provided on the ceramic substrate 14, in particular by means of a paste printing process, the power of the element being controlled by a transistor 26, 27, respectively. The transistors 26, 27 and other electronic components 28 form a control unit 31 or are part of such a unit and are located within the control zone 19 which, moreover, comprises a conductor path layout 30 with contact regions 32.

The heating zones 16, 18 are each covered with an electrically insulating thermally conductive Kapton® film 34, 35 as the cover elements 36, 37. On the cover elements 36, 37, a respective layer of a thermally conductive paste 38 and 39 is provided. Each cover element 36, 37 ends close to the control zone 19 so that the components are exposed within the control zone 19.

As an alternative, the heating element 12 can also comprise a composite structure of a ceramic substrate with printed heating conductors, glass passivation layers on the heating conductors, glass solder layers on the glass passivation layers and ceramic cover elements that are fixedly bonded with the glass passivation layers by means of the glass solder layers. Such a composite structure is described in WO 2011/085915 A1, for example. This composite structure is hermetically sealed, as well as electrically highly resistant to disruptive discharge and is thus safe to touch and resistant to humidity.

From the bottom side 21 of the ceramic substrate 14, as illustrated in FIG. 2, a first cooling body 42 abuts on the lower cover element 37, which cooling body extends along the entire length of the heating zones 16, 18 and the control zone 19. The first cooling body 42 is made of a thermally conductive metal material, such as an aluminum alloy, and includes a base plate 44 from which individual cooling fins 46 project with cooling fin sections 47 tilted in opposite directions, seen in the flow direction of the air (i.e. along the extension of the gap between the cooling fins 46). A second cooling body 48 rests on the upper ceramic cover element 36, which, similar to the first cooling body 42, is thermally coupled to the ceramic cover element 36. The second cooling body 48 has a structure similar to the first cooling body 42 and comprises a base plate 50 with cooling fins 52 projecting therefrom, as well as tilted cooling fin sections 53.

If the resistance-heating conductors 23, 25 of both heating zones 16, 18 are formed on a common side of the ceramic substrate 14 (e.g. the upper side 20 in FIG. 2), the first cooling body 42 can have a base plate 44 protruding beyond the series of cooling fins 46, wherein the protruding portion 40 thereof contacts the bottom side 21 of the ceramic substrate 14 in a thermally coupled manner in the region of the control zone 19 thereof.

Both cooling bodies 42, 48 are held together by means of clamp elements 54 and are thus retained on the heating element 12 on both sides.

The heat generated within the respective heating zone 16 or 18 is dissipated into the environment via the two cooling bodies 42, 48, with the entire heating module 10 being designed such that the control zone 19, although arranged immediately net to the heating zone 16, can be maintained at a temperature at which the functionality of the electronic components is not impaired. Using a temperature sensor 56, the temperature of the control zone 19 can be detected, thereby allowing for temperature monitoring. Furthermore, such temperature monitoring can be realized by concluding on the temperature of the heating element 12 from the current characteristic of the resistance-heating conductor. Preferably, the temperature of the ceramic substrate is monitored continuously. Owing to this temperature monitoring, an electronic limitation of the temperature and thus of the power of the heating element 12 becomes possible. Further, the transistor 26 is protected against overheating.

If the heating module is used to heat a liquid, e.g. water, the cooling body or the cooling bodies is/are configured as heat exchanger housings, for example, through which the liquid flows (separated and sealed from the electrical components of the heating module 10). It is conceivable that the liquid to be heated first flows through a first heat exchanger thermally coupled to a first side of the ceramic substrate 14, to be thereafter directed through a second heat exchanger thermally coupled to a second side of the ceramic substrate 14. Due to the fact that the liquid flow passes different heating zones (namely one on each side or a plurality on each side of the substrate) that can be controlled independently of each other, an overheating or even a seething of the liquid at the outlet or in the region of the outlet of the electrical liquid heater can be avoided by a corresponding control of the different heating zones.

It is possible to assemble a plurality of heating modules 10, illustrated in FIGS. 1 to 3, can then be assembled to an electronic heater 58. With reference to FIG. 4, the electrical heater 58 has a frame 60 in which, in the present embodiment, three heating modules 10 are arranged one above the other. Here, the cooling fins 46 and 52 of the adjacently arranged cooling bodies 42 and 48 of juxtaposed heating elements 12 mesh with one another. The contact regions 32 of the control zones 19 of the heating modules 10 are electrically connected with a control and evaluation unit 62. Owing to the meshing cooling fins 46, 52, the electrical heater 58, seen across its flow section, has a higher flow resistance between the adjacent heating modules 10 than in the region of the two, with respect to the electrical heater 58, outer cooling bodies 42, 48. In order to achieve a flow resistance adapted to the flow resistance between the heating modules 10 also in these regions, the frame sections 64 extending on both sides, as illustrated in FIG. 4, have covers 66 that partly cover the cooling fins 46, 52.

Referring to FIG. 4, three heating modules as illustrated in FIGS. 1 to 3 are installed in the electrical heater 58, which heating modules extend horizontally in the mounted state. The heating zones 16, 18, thereby arranged side by side, make it possible to heat the left portion 70, with reference to FIG. 4, of the airflow indicated at 68 to a temperature different from that of its right portion 72.

FIG. 5 illustrates an additional electrical heater 58′ that comprises four vertically oriented heating modules 10 which in the assembled state of the electrical heater 58′ are directed vertically. As far as the individual components of the heater 58′ correspond to those of the heater 58 in FIG. 4, they are identified by the same reference numerals as in FIG. 4.

Again, the airflow indicated at 68 and passing through the electrical heater 58′ can be heated in its left half 70, with reference to FIG. 5, to a temperature value different from that of the right half 72. This does not necessarily require a differential control of the two heating zones 16, 18 of the individual heating modules 10. Rather, it is merely necessary that the heating modules 10 associated with the different air flow halves 70, 72 are controlled differently from each other. If, in addition, the heating zones 16, 18 are also controlled differently, the airflow (see 68) traversing the electrical heater 58′ can be controlled to different temperatures in its four quadrants 70, 72, 74, 76.

The concepts shown in FIGS. 4 and 5 can analogously be applied to the case that the medium to be heated is a liquid. In this case as well, a right/left separation or, seen across the cross section, a temperature stratification or a temperature gradient can be realized, which is particularly useful with laminar flows.

### LIST OF REFERENCE NUMERALS

10 heating module

12 electrical heating element of the heating module

14 ceramic substrate of the heating module

16 heating zone of the ceramic substrate

18 heating zone of the ceramic substrate

19 control zone of the ceramic substrate

20 upper side of the ceramic substrate

21 bottom side of the ceramic substrate

22 resistance-heating element on the ceramic substrate

23 resistance-heating conductor

24 resistance-heating element on the ceramic substrate

25 resistance-heating conductor

26 transistor

27 transistor

28 electric/electronic components of the control unit

30 conductor path layout

31 control unit

32 contact regions

36 cover element of the heating module

37 cover element of the heating module

38 thermally conductive paste

39 thermally conductive paste

40 protruding portion of the ceramic substrate

42 cooling body

44 base plate of the cooling body

46 cooling fins of the cooling body

47 cooling fin sections

48 cooling body

50 base plate of the cooling body

52 cooling fins of the cooling body

53 cooling fin sections

54 clamp elements

56 temperature sensor

58 electrical heater

58′ electrical heater

60 frame of the heater

62 evaluation unit of the heater

64 frame portions of the frame

66 covers of the frame

68 airflow through the heating

70 left half of the airflow through the heating

72 right half of the airflow through the heating

74 quadrant of the airflow

76 quadrant of the airflow

1. An electrical vehicle heater, in particular for vehicles having a hybrid drive or having an electric drive, comprising
a heating module provided with
a carrier body having two opposite main outside surfaces,
wherein the carrier body—when observed in the direction of one of the two main outside surfaces—is divided into two adjacent heating zones, and
wherein the carrier body is provided with at least one heating element in each heating zone,
a control unit for controlling the heating elements independently of each other, and
at least one heat exchanger for dissipating thermal energy to a heat transport medium, the heat exchanger being thermally coupled to the carrier body.

2. The electrical vehicle heater of claim 1, wherein the heating elements associated with the two heating zones are arranged on a common main outside surface of the carrier body.

3. The electrical vehicle heater of claim 1, wherein the at least one heating element of the one heating zone is arranged on one main outside surface of the carrier body, and that the at least one heating element of the other heating zone is arranged on the other main outside surface of the carrier body.

4. The electrical vehicle heater of claim 1, wherein the control unit is arranged in a region of the carrier body situated outside the heating zones or in a plurality of such regions of the carrier body.

5. The electrical vehicle heater of claim 1, comprising two heat exchangers between which the carrier body is arranged.

6. The electrical vehicle heater of claim 1, wherein the carrier body is strip-shaped and has a longitudinal extension, and that the two heating zones are arranged one after the other along the longitudinal extension on a common main outside surface of the carrier body or on different main outside surfaces of the carrier body with or without mutual overlap.

7. The electrical vehicle heater of claim 1, wherein the carrier body comprises a ceramic substrate, that the heating elements are respectively formed as heating conductor paths, and that each heating conductor path is covered with one or a plurality of cover elements fixedly connected with the ceramic substrate.

8. The electrical vehicle heater of claim 4, wherein the ceramic substrate has at least one protruding portion projecting beyond the cover element, and that components of a control circuit for the heating elements are arranged in the protruding portion of the ceramic substrate

9. The electrical vehicle heater of claim 7, wherein the or each cover element is designed as a thermally conductive, as well as electrically insulating plastic film which in particular comprises an imido compound or a polyimide, or that the cover element comprises a passivation layer, in particular of glass, and/or that a thermally conductive paste is provided between each of the main outside surfaces which is provided with at least one heating element, and the cover element or between the cover element and a heat exchanger.

10. The electrical vehicle heater of claim 1, wherein the or each heat exchanger can comprise a cooling body with a plurality of mutually adjacent projecting cooling fins between which the heat transport medium can flow through, wherein at least some of the cooling fins have cooling fin sections tilted in opposite directions—seen in the flow direction of the heat transport medium.

11. The electrical vehicle heater of claim 1, wherein the heat transport medium flows through and/or around the heat exchanger, thereby forming two partial flows, each of the partial flows being associated with another heating zone of the heating module.

12. The electrical vehicle heater of claim 11, wherein a plurality of heating modules are provided, each heating module being associated with respective partial flows.

13. The electrical vehicle heater of claim 11, wherein a plurality of heating modules are provided, of which a first set of heating modules, comprising at least one heating module, is associated with a respective one of two partial flows, namely a first or a second partial flow, and of which a second set of heating modules, comprising at least one heating module, is associated with a respective one of two further partial flows, namely a third or a fourth partial flow, wherein the one heating zone of the at least one heating module of the first set is associated with the first partial flow, the other heating zone of the at least one heating module of the first set is associated with the second partial flow, the one heating zone of the at least one heating module of the second set is associated with the third partial flow, and the other heating zone of the at least one heating module of the second set is associated with the fourth partial flow.
